(19) United States
(12) Patent Application Publication
(10) Pub. No.: US 2025/0265489 A1
(43) Pub. Date: Aug. 21, 2025

(54) QUERY-BASED MODEL AND PROMPT TEMPLATE SELECTION

(71) Applicant: International Business Machines Corporation, Armonk, NY (US)

(72) Inventors: Yara Rizk, Cambridge, MA (US); Walter Gerych, Framingham, MA (US); Vatche Isahagian, Belmont, MA (US); Vinod Muthusamy, Austin, TX (US); Praveen Venkateswaran, Cambridge, MA (US); EVELYN DUESTERWALD, Millwood, NY (US)

(73) Assignee: International Business Machines Corporation, Armonk, NY (US)

(21) Appl. No.: 18/442,643

(22) Filed: Feb. 15, 2024

(51) Int. Cl. G06N 20/00; G06Q 30/04

(52) U.S. Cl. CPC G06N 20/00; G06Q 30/04

(57) ABSTRACT

An embodiment computes, using a trained embedding model, a query embedding representing an input query, the input query comprising a request for a recommended model and a recommended prompt template for use with the recommended model. An embodiment selects a set of nearest neighbor embeddings with a distance less than a threshold distance from the query embedding in an embedding space. An embodiment predicts, using a trained confidence predictor model, a confidence value of each model-prompt template pair represented by a nearest neighbor embedding in the set of nearest neighbor embeddings, the predicting resulting in a set of predicted confidence values. An embodiment constructs a response to the input query, the response comprising a model-prompt template pair selected using the predicted confidence values.

### BACKGROUND

The present invention relates generally to machine learning models. More particularly, the present invention relates to a method, system, and computer program for query-based model and prompt template selection.

Generative artificial intelligence, or a generative model, refers to a machine learning model that generates natural language text, images or video, or other content based on the data the model was trained on. For example, a large language model (LLM) is a generative model that generates text. Simplifying, a generative model encodes a simplified representation of the model's training data and uses that encoded representation to create a new work that is similar, but not identical, to the original training data. A foundation model is a generative model that is trained on a broad set of unlabeled data. A foundation model can be adapted to specific knowledge domains or specialized tasks with additional fine-tuning, creating a fine-tuned model.

A prompt is a set of instructions or guidelines, input to a generative model, that guides the model's output. A prompt template includes one or more placeholders that can be replaced with specific input. For example, a prompt template designed to have a model answer physics questions might be, “Answer the following physics question: {input} {response}”, where {input} and {response} are placeholders. Prompt engineering refers to adjusting the wording or structure of a prompt or prompt template, or by providing additional information, parameter settings, or context, to control the model's output. Prompt engineering can be used to optimize results of a foundation model without having to re-train or fine-tune the model.

### SUMMARY

The illustrative embodiments provide for query-based model and prompt template selection. An embodiment includes computing, using a trained embedding model, a query embedding representing an input query, the input query comprising a request for a recommended model and a recommended prompt template for use with the recommended model. An embodiment includes selecting a set of nearest neighbor embeddings with a distance less than a threshold distance from the query embedding in an embedding space. An embodiment includes predicting, using a trained confidence predictor model, a confidence value of each model-prompt template pair represented by a nearest neighbor embedding in the set of nearest neighbor embeddings, the predicting resulting in a set of predicted confidence values. An embodiment includes constructing a response to the input query, the response comprising a model-prompt template pair selected using the predicted confidence values. Other embodiments of this aspect include corresponding computer systems, apparatus, and computer programs recorded on one or more computer storage devices, each configured to perform the actions of the embodiment.

An embodiment includes a computer usable program product. The computer usable program product includes a computer-readable storage medium, and program instructions stored on the storage medium.

An embodiment includes a computer system. The computer system includes a processor, a computer-readable memory, and a computer-readable storage medium, and program instructions stored on the storage medium for execution by the processor via the memory.

### BRIEF DESCRIPTION OF THE DRAWINGS

The novel features believed characteristic of the invention are set forth in the appended claims. The invention itself, however, as well as a preferred mode of use, further objectives, and advantages thereof, will best be understood by reference to the following detailed description of the illustrative embodiments when read in conjunction with the accompanying drawings, wherein:

FIG. 1 depicts a block diagram of a computing environment in accordance with an illustrative embodiment;

FIG. 2 depicts a flowchart of an example process for loading of process software in accordance with an illustrative embodiment;

FIG. 3 depicts a block diagram of an example configuration for query-based model and prompt template selection in accordance with an illustrative embodiment;

FIG. 4 depicts an example of query-based model and prompt template selection in accordance with an illustrative embodiment;

FIG. 5 depicts a continued example of query-based model and prompt template selection in accordance with an illustrative embodiment;

FIG. 6 depicts a continued example of query-based model and prompt template selection in accordance with an illustrative embodiment;

FIG. 7 depicts a continued example of query-based model and prompt template selection in accordance with an illustrative embodiment;

FIG. 8 depicts a continued example of query-based model and prompt template selection in accordance with an illustrative embodiment; and

FIG. 9 depicts a flowchart of an example process for query-based model and prompt template selection in accordance with an illustrative embodiment.

### DETAILED DESCRIPTION

The illustrative embodiments recognize that users have a choice of many foundation models. Some models are better at some tasks and worse on others, and model performance is heavily dependent on the prompt used. For example, models exhibit sensitivity to the specific examples chosen to illustrate a task the model should perform, or exhibit brittleness to the wording of instructions. Moreover, a prompt template that makes a model perform well for one input may not be the optimal template for another input to the same model. Thus, the illustrative embodiments recognize that there is an unmet need to, given one or a few examples of a task a foundation model is to perform, determine the best model and prompt template combination to use for that task. In addition, because a model or prompt template that works best for a task overall may not be optimal for each particular input calling for a task, even if that input is from the same task, there is also an unmet need to determine the best model and prompt template combination to use for a given input. Both one or a few examples of a task a foundation model is to perform and a particular input calling for a task are referred to as queries, and in both cases the response to the query is a model and prompt template pair.

The illustrative embodiments also recognize that one typically used model selection strategy is to select the model that is most confident in its response, using a confidence measurement technique such as measuring the semantic similarity between multiple samples, or outputs, from the model in response to the same prompt and determining how much prompt variation is required to change a model's response by an amount above a threshold. However, existing confidence approaches require obtaining at least one (and often many) response from a model before confidence can be estimated. As calculating the confidence of all the possible pairs of models and prompt templates would incur a quadratic number of calls to a model for each pair, calculating confidence directly is not feasible when choosing between multiple models and prompt templates. As well, determining the best model and prompt template combination to use for a given input would require calling a model not only for each model and prompt template pair, but instead for each user input. In addition, confidence cannot be computed for all models and prompt templates. Thus, the illustrative embodiments recognize that there is an unmet need for a different method of selecting the most confident model and prompt template pair using an estimated confidence that does not require observing the output of each model being evaluated.

The present disclosure addresses the deficiencies described above by providing a process (as well as a system, method, machine-readable medium, etc.) that computes, using a trained embedding model, a query embedding representing to an input query, the input query comprising a request for a recommended model and a recommended prompt template for use with the recommended model; selects a set of nearest neighbor embeddings with a distance less than a threshold distance from the query embedding in an embedding space; predicts, using a trained confidence predictor model, a confidence value of each model-prompt template pair represented by a nearest neighbor embedding; and constructs a response to the input query, the response comprising a model-prompt template pair selected using the predicted confidence values. Thus, the illustrative embodiments provide for automated detection of query-based model and prompt template selection.

An illustrative embodiment has access to a confidence predictor model training dataset, including data of models that are being evaluated for use with a user query, and prompt templates that are available to be paired with the models being evaluated. The training dataset also includes sample queries, or inputs, to a model being evaluated. For example, if an LLM is being evaluated, the training dataset includes text queries to a model being evaluated. As another example, if an image generation model is being evaluated, the training dataset includes queries to a model being evaluated (in text, image, or another form).

An embodiment uses a trained embedding model to compute a plurality of training data embeddings, each representing an input to a model in the training dataset. An embedding represents coordinates of a point in an embedding space. Proximity in the embedding space corresponds to semantic similarity in the inputs (e.g., queries) represented by embeddings. For example, using an embedding model that considers animals to be more similar to each other than non-animals, embeddings representing “cat” and “dog” would be closer to each other in the embedding space than either would be to an embedding representing “airplane”. Techniques for generating embeddings and training embedding models are presently available. Techniques for measuring distance between embeddings, for example cosine similarity, are also presently available.

An embodiment computes a confidence value on a training data embedding. In particular, an embodiment selects model-prompt template pairs from the training dataset. For a selected model-prompt template pair, an embodiment causes the model, using the prompt template supplemented with training data, and a given input, to generate a plurality of responses, using a particular temperature. Temperature is a model input parameter influencing randomness and creativity in model output, by adjusting probabilities in the output layer of the model. An embodiment counts the number of responses that have above a threshold similarity to each other, divides that number by the total number of answers, and uses the result as a confidence value. Techniques for computing a similarity or similarity score, such as by using an LLM, computing a cosine similarity, or using a Recall-Oriented Understudy for Gisting Evaluation (ROUGE) metric such as ROUGE-L, or another technique, are presently available.

An embodiment uses a presently available technique, and computed confidence values on training data embeddings, to train a plurality of regression models to predict confidence of a point in an embedding space given the confidence and distance of the point's neighbors in the embedding space.

An embodiment receives an input query from a user. The input query includes a request for a recommended model and a recommended prompt template for use with the recommended model. In one embodiment, the input query includes one or more examples of a task the recommended model and the recommended prompt template are being selected to perform. For example, a user might provide several examples of questions asking where something is (a task the user wants an LLM recommendation for) and ask for a recommended model and prompt template for use on similar questions. In another embodiment, the input query includes a query requesting a response from the recommended model using the recommended prompt template. For example, a user might provide a question (e.g., where was The Hobbit filmed?) and expect a response to the question, using a recommended model and prompt template.

An embodiment uses the same trained embedding model as was used to compute training data embeddings to compute a query embedding representing an input query. A query embedding is a multidimensional numerical representation of an input query, and hence is also a vector representing coordinates of a point in an embedding space.

An embodiment uses the same trained embedding model to compute a plurality of model-prompt template embeddings. Each model-prompt template embedding represents a pair: a model available for use in responding to the input query (i.e., a candidate model) and a prompt template for use with that model (i.e., a candidate prompt template).

An embodiment selects a set of model-prompt template embeddings with a distance less than a threshold distance from the query embedding in the embedding space. The set of model-prompt template embeddings are thus nearest neighbor embeddings. Because proximity in the embedding space corresponds to semantic similarity in the items represented by embeddings, each nearest neighbor embedding represents a model-prompt template pair that is semantically similar to the query represented by the query embedding.

An embodiment uses the trained confidence predictor model to predict a confidence value of each model-prompt template pair represented by a nearest neighbor embedding. In other words, an embodiment uses the trained confidence predictor model to predict nearest neighbor confidence values. An embodiment uses the predicted nearest neighbor confidence values to compute a confidence value for the query. One embodiment computes a feature representation of a query, denoted by features (query), by computing a vector addition of predicted confidence values and corresponding cosine similarities of nearest neighbor embeddings to the query embedding. Another embodiment computes a feature representation of a query, denoted by features (query), by computing a vector addition of predicted confidence values and a softmax operation on corresponding cosine similarities of nearest neighbor embeddings to the query embedding. Another embodiment computes a feature representation of a query, denoted by features (query), by computing a vector multiplication of predicted confidence values and a softmax operation on corresponding cosine similarities of nearest neighbor embeddings to the query embedding. The softmax operation takes as input a vector of K real numbers, and normalizes the vector into a probability distribution consisting of K probabilities proportional to the exponentials of the input numbers. After applying softmax, each vector component will be between zero and one, and the components of the vector sum to one.

An embodiment constructs a response to the input query. The response includes a model-prompt template pair selected using the predicted confidence values. In particular, one embodiment computes an average confidence value for each model-prompt template pair represented by a nearest neighbor embedding, selects the model-prompt template pair with the highest average predicted confidence value, and incorporates the selected model-prompt template pair into a response to the input query. Another embodiment selects the model-prompt template pair with the highest predicted confidence value, and incorporates the selected model-prompt template pair into a response to the input query.

If the input query requested a response from a recommended model, one embodiment uses the model-prompt template pair with the highest predicted or highest average predicted confidence value to generate a candidate response to the input query, and incorporates the candidate response into a response to the input query. Another embodiment uses the model-prompt template pair with the highest predicted or highest average predicted confidence value to generate a plurality of candidate responses to the input query, and computes similarity scores between pairs of candidate responses in the plurality of candidate responses. For example, an embodiment might compute a similarity score between candidate responses 1 and 2, between candidate responses 1 and 3, between candidate responses 1 and 4, and so on. An embodiment combines each candidate's similarity scores into a combined similarity score. One embodiment averages each candidate's similarity scores together. For example, the embodiment might average the similarity scores between candidate responses 1 and each other candidate response into an average similarity score for candidate response 1. Another embodiment computes a weighted average of each candidate's similarity scores. Other similarity score combination techniques are also possible and contemplated within the scope of the illustrative embodiments. An embodiment incorporates the candidate response with the highest combined (e.g., the highest average) similarity score into a response to the input query.

For the sake of clarity of the description, and without implying any limitation thereto, the illustrative embodiments are described using some example configurations. From this disclosure, those of ordinary skill in the art will be able to conceive many alterations, adaptations, and modifications of a described configuration for achieving a described purpose, and the same are contemplated within the scope of the illustrative embodiments.

Furthermore, simplified diagrams of the data processing environments are used in the figures and the illustrative embodiments. In an actual computing environment, additional structures or components that are not shown or described herein, or structures or components different from those shown but for a similar function as described herein may be present without departing the scope of the illustrative embodiments.

Furthermore, the illustrative embodiments are described with respect to specific actual or hypothetical components only as examples. Any specific manifestations of these and other similar artifacts are not intended to be limiting to the invention. Any suitable manifestation of these and other similar artifacts can be selected within the scope of the illustrative embodiments.

The examples in this disclosure are used only for the clarity of the description and are not limiting to the illustrative embodiments. Any advantages listed herein are only examples and are not intended to be limiting to the illustrative embodiments. Additional or different advantages may be realized by specific illustrative embodiments. Furthermore, a particular illustrative embodiment may have some, all, or none of the advantages listed above.

Furthermore, the illustrative embodiments may be implemented with respect to any type of data, data source, or access to a data source over a data network. Any type of data storage device may provide the data to an embodiment of the invention, either locally at a data processing system or over a data network, within the scope of the invention. Where an embodiment is described using a mobile device, any type of data storage device suitable for use with the mobile device may provide the data to such embodiment, either locally at the mobile device or over a data network, within the scope of the illustrative embodiments.

The illustrative embodiments are described using specific code, computer readable storage media, high-level features, designs, architectures, protocols, layouts, schematics, and tools only as examples and are not limiting to the illustrative embodiments. Furthermore, the illustrative embodiments are described in some instances using particular software, tools, and data processing environments only as an example for the clarity of the description. The illustrative embodiments may be used in conjunction with other comparable or similarly purposed structures, systems, applications, or architectures. For example, other comparable mobile devices, structures, systems, applications, or architectures therefor, may be used in conjunction with such embodiment of the invention within the scope of the invention. An illustrative embodiment may be implemented in hardware, software, or a combination thereof.

The examples in this disclosure are used only for the clarity of the description and are not limiting to the illustrative embodiments. Additional data, operations, actions, tasks, activities, and manipulations will be conceivable from this disclosure and the same are contemplated within the scope of the illustrative embodiments.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

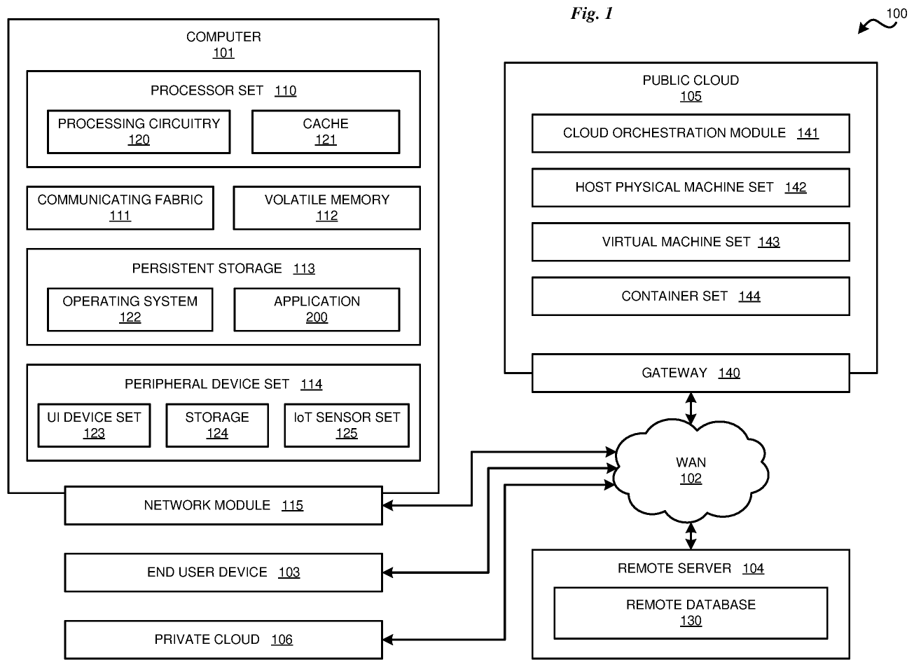

With reference to FIG. 1, this figure depicts a block diagram of a computing environment 100. Computing environment 100 contains an example of an environment for the execution of at least some of the computer code involved in performing the inventive methods, such as block 200 implementing query-based model and prompt template selection. In addition to block 200, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 200, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 200 in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up buses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface-type operating systems that employ a kernel. The code included in block 200 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

Measured service: cloud systems automatically control and optimize resource use by leveraging a metering capability at some level of abstraction appropriate to the type of service (e.g., storage, processing, bandwidth, and active user accounts). Resource usage can be monitored, controlled, reported, and invoiced, providing transparency for both the provider and consumer of the utilized service.

CLOUD COMPUTING SERVICES AND/OR MICROSERVICES (not separately shown in FIG. 1): private and public clouds 106 are programmed and configured to deliver cloud computing services and/or microservices (unless otherwise indicated, the word “microservices” shall be interpreted as inclusive of larger “services” regardless of size). Cloud services are infrastructure, platforms, or software that are typically hosted by third-party providers and made available to users through the internet. Cloud services facilitate the flow of user data from front-end clients (for example, user-side servers, tablets, desktops, laptops), through the internet, to the provider's systems, and back. In some embodiments, cloud services may be configured and orchestrated according to as “as a service” technology paradigm where something is being presented to an internal or external customer in the form of a cloud computing service. As-a-Service offerings typically provide endpoints with which various customers interface. These endpoints are typically based on a set of APIs. One category of as-a-service offering is Platform as a Service (PaaS), where a service provider provisions, instantiates, runs, and manages a modular bundle of code that customers can use to instantiate a computing platform and one or more applications, without the complexity of building and maintaining the infrastructure typically associated with these things. Another category is Software as a Service (SaaS) where software is centrally hosted and allocated on a subscription basis. SaaS is also known as on-demand software, web-based software, or web-hosted software. Four technological sub-fields involved in cloud services are: deployment, integration, on demand, and virtual private networks.

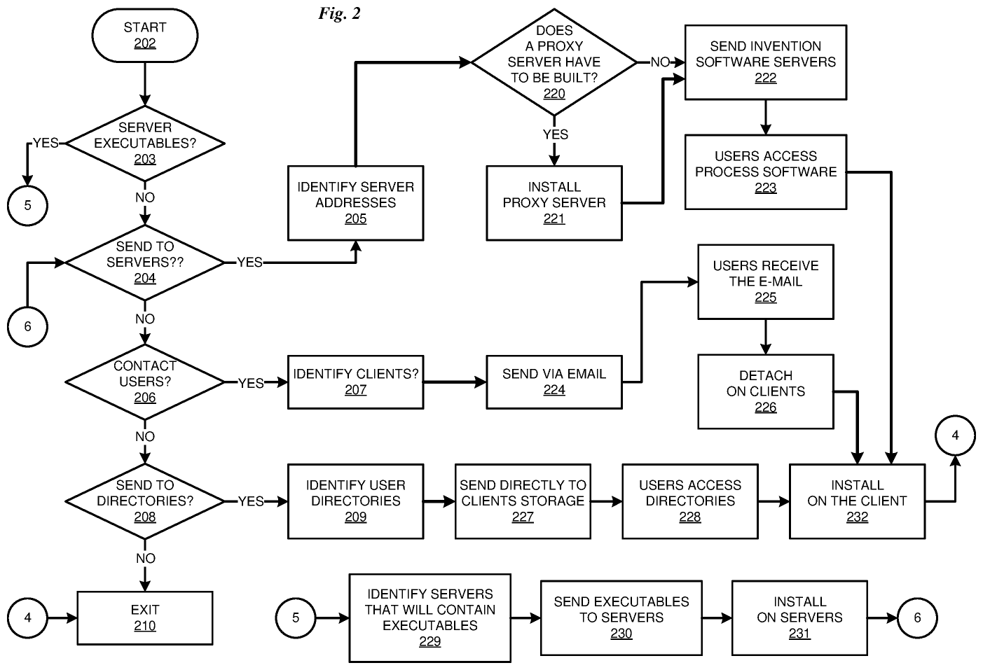

With reference to FIG. 2, this figure depicts a flowchart of an example process for loading of process software in accordance with an illustrative embodiment. The flowchart can be executed by a device such as computer 101, end user device 103, remote server 104, or a device in private cloud 106 or public cloud 105 in FIG. 1.

While it is understood that the process software implementing query-based model and prompt template selection may be deployed by manually loading it directly in the client, server, and proxy computers via loading a storage medium such as a CD, DVD, etc., the process software may also be automatically or semi-automatically deployed into a computer system by sending the process software to a central server or a group of central servers. The process software is then downloaded into the client computers that will execute the process software. Alternatively, the process software is sent directly to the client system via e-mail. The process software is then either detached to a directory or loaded into a directory by executing a set of program instructions that detaches the process software into a directory. Another alternative is to send the process software directly to a directory on the client computer hard drive. When there are proxy servers, the process will select the proxy server code, determine on which computers to place the proxy servers' code, transmit the proxy server code, and then install the proxy server code on the proxy computer. The process software will be transmitted to the proxy server, and then it will be stored on the proxy server.

Step 202 begins the deployment of the process software. An initial step is to determine if there are any programs that will reside on a server or servers when the process software is executed (203). If this is the case, then the servers that will contain the executables are identified (229). The process software for the server or servers is transferred directly to the servers' storage via FTP or some other protocol or by copying though the use of a shared file system (230). The process software is then installed on the servers (231).

Next, a determination is made on whether the process software is to be deployed by having users access the process software on a server or servers (204). If the users are to access the process software on servers, then the server addresses that will store the process software are identified (205).

A determination is made if a proxy server is to be built (220) to store the process software. A proxy server is a server that sits between a client application, such as a Web browser, and a real server. It intercepts all requests to the real server to see if it can fulfill the requests itself. If not, it forwards the request to the real server. The two primary benefits of a proxy server are to improve performance and to filter requests. If a proxy server is required, then the proxy server is installed (221). The process software is sent to the (one or more) servers either via a protocol such as FTP, or it is copied directly from the source files to the server files via file sharing (222). Another embodiment involves sending a transaction to the (one or more) servers that contained the process software, and have the server process the transaction and then receive and copy the process software to the server's file system. Once the process software is stored at the servers, the users via their client computers then access the process software on the servers and copy to their client computers file systems (223). Another embodiment is to have the servers automatically copy the process software to each client and then run the installation program for the process software at each client computer. The user executes the program that installs the process software on his client computer (232) and then exits the process (210).

In step 206 a determination is made whether the process software is to be deployed by sending the process software to users via e-mail. The set of users where the process software will be deployed are identified together with the addresses of the user client computers (207). The process software is sent via e-mail to each of the users' client computers (224). The users then receive the e-mail (225) and then detach the process software from the e-mail to a directory on their client computers (226). The user executes the program that installs the process software on his client computer (232) and then exits the process (210).

Lastly, a determination is made on whether the process software will be sent directly to user directories on their client computers (208). If so, the user directories are identified (209). The process software is transferred directly to the user's client computer directory (227). This can be done in several ways such as, but not limited to, sharing the file system directories and then copying from the sender's file system to the recipient user's file system or, alternatively, using a transfer protocol such as File Transfer Protocol (FTP). The users access the directories on their client file systems in preparation for installing the process software (228). The user executes the program that installs the process software on his client computer (232) and then exits the process (210).

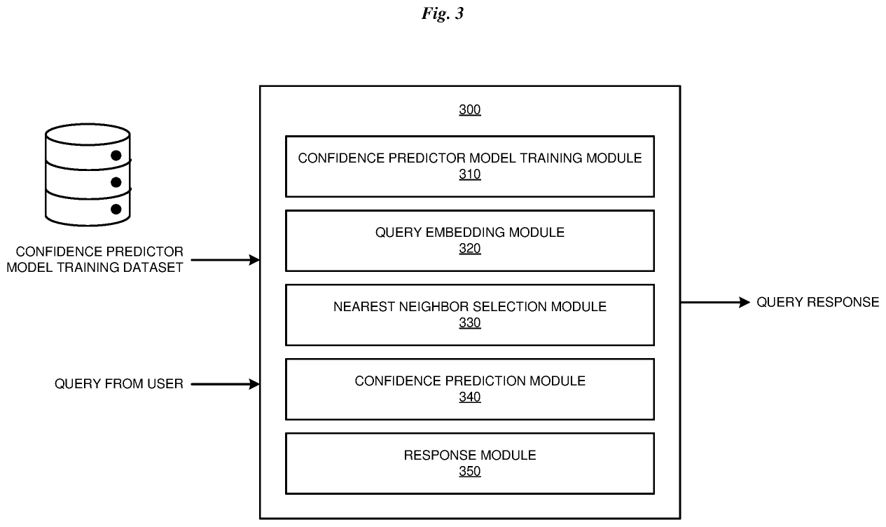

With reference to FIG. 3, this figure depicts a block diagram of an example configuration for query-based model and prompt template selection in accordance with an illustrative embodiment. Application 300 is the same as application 200 in FIG. 1.

In the illustrated embodiment, application 300 has access to a confidence predictor model training dataset, including data of models that are being evaluated for use with a user query, and prompt templates that are available to be paired with the models being evaluated. The training dataset also includes sample queries, or inputs, to a model being evaluated. For example, if an LLM is being evaluated, the training dataset includes text queries to a model being evaluated. As another example, if an image generation model is being evaluated, the training dataset includes queries to a model being evaluated (in text, image, or another form).

Confidence predictor model training module 310 uses a trained embedding model to compute a plurality of training data embeddings, each representing an input to a model in the training dataset. Module 310 represents coordinates of a point in an embedding space. Proximity in the embedding space corresponds to semantic similarity in the inputs (e.g., queries) represented by embeddings. Techniques for generating embeddings and training embedding models are presently available. Techniques for measuring distance between embeddings, for example cosine similarity, are also presently available.

Module 310 computes a confidence value on a training data embedding. In particular, module 310 selects model-prompt template pairs from the training dataset. For a selected model-prompt template pair, module 310 causes the model, using the prompt template and a given input, to generate a plurality of responses, using a particular temperature. Temperature is a model input parameter influencing randomness and creativity in model output, by adjusting probabilities in the output layer of the model. Module 310 counts the number of responses that have above a threshold similarity to each other, divides that number by the total number of answers, and uses the result as a confidence value. Techniques for computing a similarity or similarity score, such as by using an LLM, computing a cosine similarity, or using a Recall-Oriented Understudy for Gisting Evaluation (ROUGE) metric such as ROUGE-L, or another technique, are presently available.

Module 310 uses a presently available technique, and computed confidence values on training data embeddings, to train a plurality of regression models to predict confidence of a point in an embedding space given the confidence and distance of the point's neighbors in the embedding space.

Query embedding module 320 receives an input query from a user. The input query includes a request for a recommended model and a recommended prompt template for use with the recommended model. In one implementation of module 320, the input query includes one or more examples of a task the recommended model and the recommended prompt template are being selected to perform. For example, a user might provide several examples of questions asking where something is (a task the user wants an LLM recommendation for) and ask for a recommended model and prompt template for use on similar questions. In another implementation of module 320, the input query includes a query requesting a response from the recommended model using the recommended prompt template. For example, a user might provide a question (e.g., where was The Hobbit filmed?) and expect a response to the question, using a recommended model and prompt template.

Query embedding module 320 uses the same trained embedding model as was used to compute training data embeddings to compute a query embedding representing an input query. A query embedding is a multidimensional numerical representation of an input query, and hence is also a vector representing coordinates of a point in an embedding space.

Query embedding module 320 uses the same trained embedding model to compute a plurality of model-prompt template embeddings. Each model-prompt template embedding represents a pair: a model available for use in responding to the input query (i.e., a candidate model) and a prompt template for use with that model (i.e., a candidate prompt template).

Nearest neighbor selection module 330 selects a set of model-prompt template embeddings with a distance less than a threshold distance from the query embedding in the embedding space. The set of model-prompt template embeddings are thus nearest neighbor embeddings. Because proximity in the embedding space corresponds to semantic similarity in the items represented by embeddings, each nearest neighbor embedding represents a model-prompt template pair that is semantically similar to the query represented by the query embedding.

Confidence prediction module 340 uses the trained confidence predictor model to predict a confidence value of each model-prompt template pair represented by a nearest neighbor embedding. In other words, an embodiment uses the trained confidence predictor model to predict nearest neighbor confidence values. An embodiment uses the predicted nearest neighbor confidence values to compute a confidence value for the query. One embodiment computes a feature representation of a query, denoted by features (query), by computing a vector addition of predicted confidence values and corresponding cosine similarities of nearest neighbor embeddings to the query embedding. Another embodiment computes a feature representation of a query, denoted by features (query), by computing a vector addition of predicted confidence values and a softmax operation on corresponding cosine similarities of nearest neighbor embeddings to the query embedding. Another embodiment computes a feature representation of a query, denoted by features (query), by computing a vector multiplication of predicted confidence values and a softmax operation on corresponding cosine similarities of nearest neighbor embeddings to the query embedding.

Response module 350 constructs a response to the input query. The response includes a model-prompt template pair selected using the predicted confidence values. In particular, one implementation of module 350 computes an average confidence value for each model-prompt template pair represented by a nearest neighbor embedding, selects the model-prompt template pair with the highest average predicted confidence value, and incorporates the selected model-prompt template pair into a response to the input query. Another implementation of module 350 selects the model-prompt template pair with the highest predicted confidence value, and incorporates the selected model-prompt template pair into a response to the input query.

If the input query requested a response from a recommended model, one implementation of module 350 uses the model-prompt template pair with the highest predicted or highest average predicted confidence value to generate a candidate response to the input query, and incorporates the candidate response into a response to the input query. Another implementation of module 350 uses the model-prompt template pair with the highest predicted or highest average predicted confidence value to generate a plurality of candidate responses to the input query, and computes similarity scores between pairs of candidate responses in the plurality of candidate responses. For example, module 350 might compute a similarity score between candidate responses 1 and 2, between candidate responses 1 and 3, between candidate responses 1 and 4, and so on. Module 350 combines each candidate's similarity scores into a combined similarity score. One implementation of module 350 averages each candidate's similarity scores together. For example, the embodiment might average the similarity scores between candidate responses 1 and each other candidate response into an average similarity score for candidate response 1. Another implementation of module 350 computes a weighted average of each candidate's similarity scores. Other similarity score combination techniques are also possible. Module 350 incorporates the candidate response with the highest combined (e.g., the highest average) similarity score into a response to the input query.

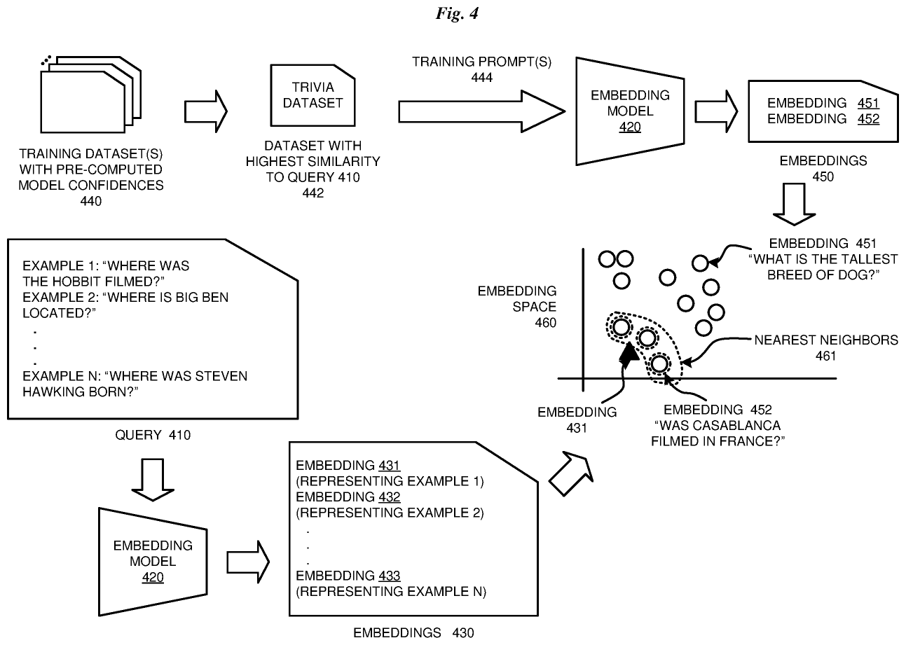

With reference to FIG. 4, this figure depicts an example of query-based model and prompt template selection in accordance with an illustrative embodiment. The example can be executed using application 300 in FIG. 3.

As depicted, query 410 includes examples of a task the recommended model and the recommended prompt template are being selected to perform. Embedding model 420 generates embeddings 430, including embedding 431, embedding 432, and embedding 433. Each of embedding 431, embedding 432, and embedding 433 represents one of the examples in query 410.

Application 300 uses training dataset(s) with pre-computed model confidences 440 to select dataset 442, a dataset with a highest similarity to query 410. Application 300 selects training prompts 444 from dataset 442, forms training prompts 444 into model-prompt template pairs. Embedding model 420 generates embeddings 450, including embedding 451 and embedding 452, each representing a model-prompt template pair: a model available for use in responding to the input query (i.e., a candidate model) and a prompt template for use with that model (i.e., a candidate prompt template).

The embeddings are plotted within embedding space 460. In particular, embedding 431 has nearest neighbors 461, a set of model-prompt template embeddings with a distance less than a threshold distance from the query embedding in the embedding space.

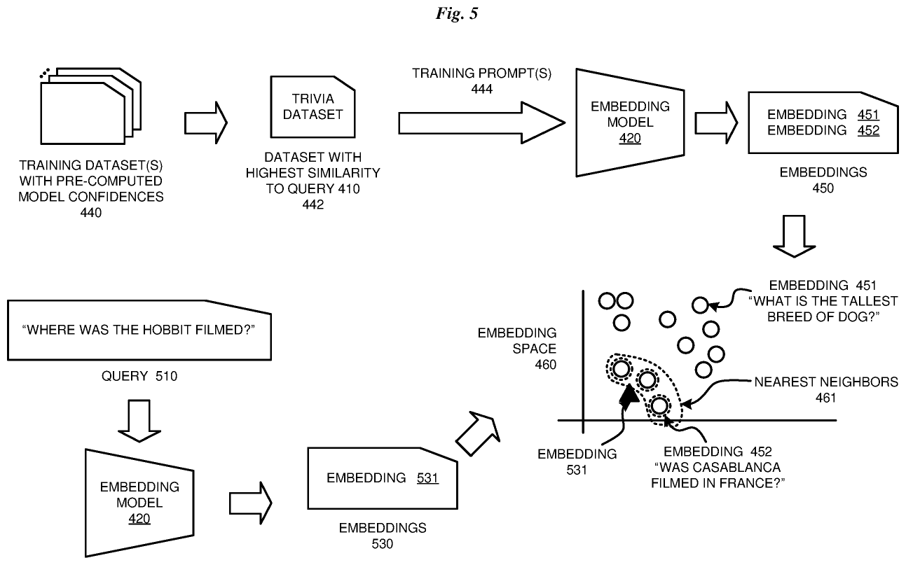

With reference to FIG. 5, this figure depicts a continued example of query-based model and prompt template selection in accordance with an illustrative embodiment. Embedding model 420, pre-computed model confidences 440, dataset 442, training prompts 444, embeddings 450, embedding 451 and embedding 452, embedding space 460, and nearest neighbors 461 are the same as embedding model 420, pre-computed model confidences 440, dataset 442, training prompts 444, embeddings 450, embedding 451 and embedding 452, embedding space 460, and nearest neighbors 461 in FIG. 4.

As depicted, query 510 includes a query requesting a response from the recommended model using the recommended prompt template. Embedding model 420 generates embeddings 530, including embedding 531, representing query 510.

The embeddings are again plotted within embedding space 460. In particular, embedding 531 has nearest neighbors 461, a set of model-prompt template embeddings with a distance less than a threshold distance from the query embedding in the embedding space.

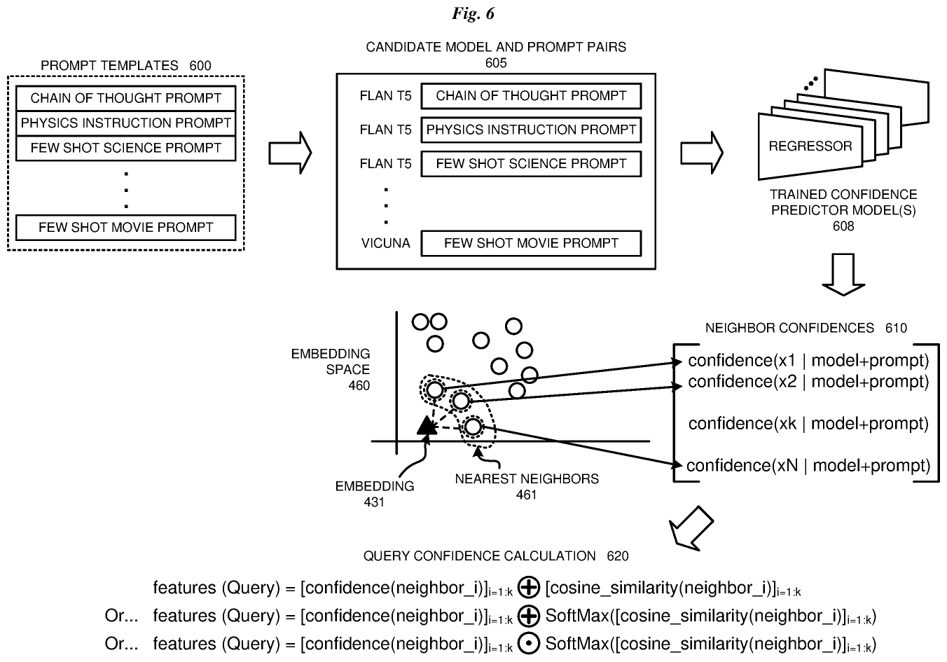

With reference to FIG. 6, this figure depicts a continued example of query-based model and prompt template selection in accordance with an illustrative embodiment. Embedding 431, embedding space 460, and nearest neighbors 461 are the same as embedding 431, embedding space 460, and nearest neighbors 461 in FIG. 4.

As depicted, prompt templates 600 have been paired with models to generate candidate model and prompt pairs 605. Note that FLAN T5 and VICUNA are candidate models. Trained confidence predictor model(s) 608 have been used to predict neighbor confidences 610, each a confidence value of model-prompt template pair represented by a nearest neighbor embedding in nearest neighbors 461. Neighbor confidences 610 are used in query confidence calculation 620. Query confidence calculation includes three possible implementations. One implementation computes a feature representation of a query, denoted by features (query), by computing a vector addition of predicted confidence values and corresponding cosine similarities of nearest neighbor embeddings to the query embedding. Another implementation computes a feature representation of a query, denoted by features (query), by computing a vector addition of predicted confidence values and a softmax operation on corresponding cosine similarities of nearest neighbor embeddings to the query embedding. Another implementation computes a feature representation of a query, denoted by features (query), by computing a vector multiplication of predicted confidence values and a softmax operation on corresponding cosine similarities of nearest neighbor embeddings to the query embedding.

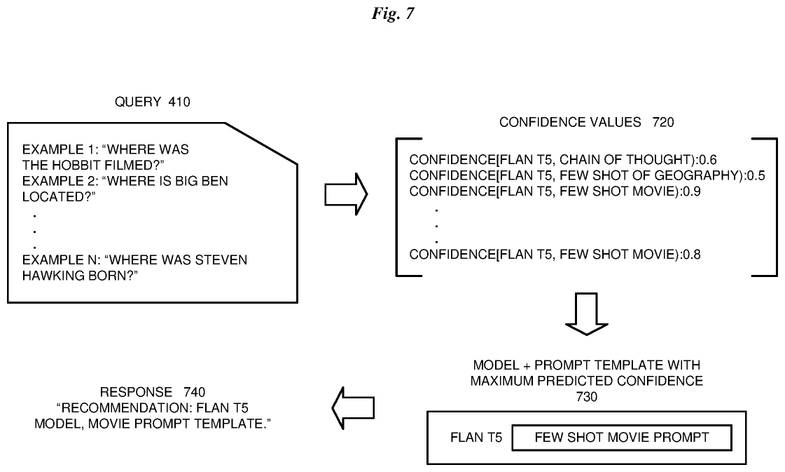

With reference to FIG. 7, this figure depicts a continued example of query-based model and prompt template selection in accordance with an illustrative embodiment. Query 410 is the same as query 410 in FIG. 4.

As depicted, responding to query 410, confidence values 720 depicts confidence values for model-prompt template pairs represented by a nearest neighbor embedding. Model+prompt template with maximum predicted confidence 730 depicts the model-prompt template pair with the highest predicted confidence value. The selected model-prompt template pair is incorporated into response 740.

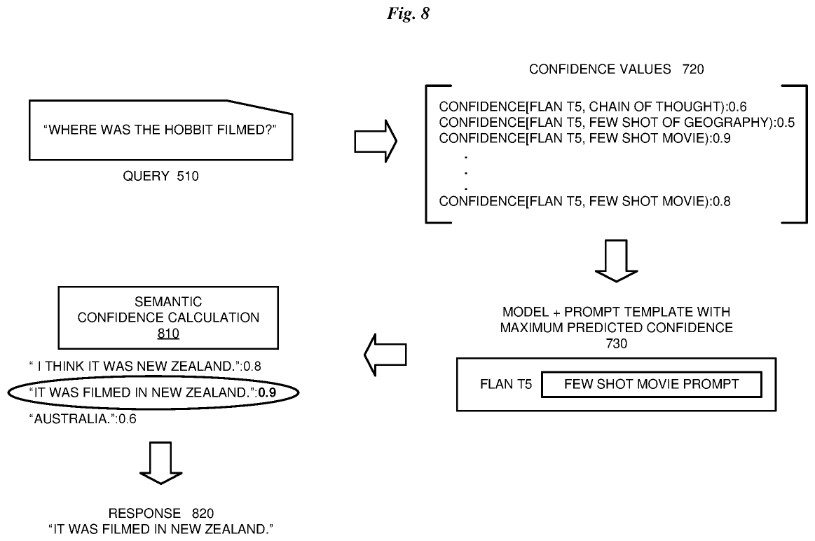

With reference to FIG. 8, this figure depicts a continued example of query-based model and prompt template selection in accordance with an illustrative embodiment. Query 510 is the same as query 510 in FIG. 5. Confidence values 720 and model+prompt template with maximum predicted confidence 730 are the same as confidence values 720 and model+prompt template with maximum predicted confidence 730 in FIG. 7.

As depicted, responding to query 510, confidence values 720 depicts confidence values for model-prompt template pairs represented by a nearest neighbor embedding. Model+prompt template with maximum predicted confidence 730 depicts the model-prompt template pair with the highest predicted confidence value. Semantic confidence calculator 810 uses pair 730 to generate a plurality of candidate responses to the input query, computes similarity scores between pairs of candidate responses in the plurality of candidate responses, and combines each candidate's similarity scores into a combined similarity score. The candidate response with the highest combined (e.g., the highest average) similarity score is incorporated into response 820, responding to query 510.

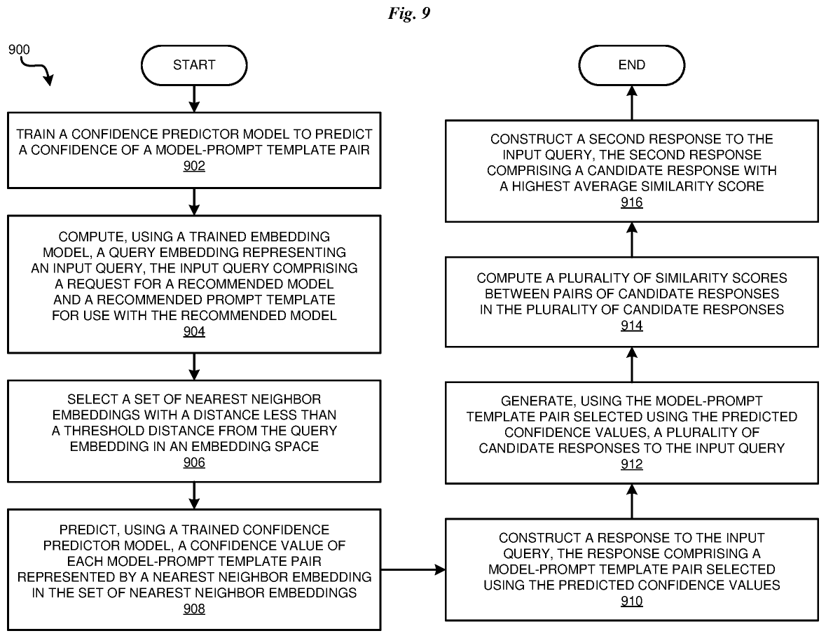

With reference to FIG. 9, this figure depicts a flowchart of an example process for query-based model and prompt template selection in accordance with an illustrative embodiment. Process 900 can be implemented in application 300 in FIG. 3.

In the illustrated embodiment, at block 902, the process trains a confidence predictor model to predict a confidence of a model-prompt template pair. At block 904, the process computes, using a trained embedding model, a query embedding representing an input query, the input query comprising a request for a recommended model and a recommended prompt template for use with the recommended model. At block 906, the process selects a set of nearest neighbor embeddings with a distance less than a threshold distance from the query embedding in an embedding space. At block 908, the process predicts, using a trained confidence predictor model, a confidence value of each model-prompt template pair represented by a nearest neighbor embedding in the set of nearest neighbor embeddings. At block 910, the process constructs a response to the input query, the response comprising a model-prompt template pair selected using the predicted confidence values. At block 912, the process generates, using the model-prompt template pair selected using the predicted confidence values, a plurality of candidate responses to the input query. At block 914, the process computes a plurality of similarity scores between pairs of candidate responses in the plurality of candidate responses. At block 916, the process constructs a second response to the input query, the second response comprising a candidate response with a highest average similarity score. Then the process ends.

The following definitions and abbreviations are to be used for the interpretation of the claims and the specification. As used herein, the terms “comprises,” “comprising,” “includes,” “including,” “has,” “having,” “contains” or “containing,” or any other variation thereof, are intended to cover a non-exclusive inclusion. For example, a composition, a mixture, process, method, article, or apparatus that comprises a list of elements is not necessarily limited to only those elements but can include other elements not expressly listed or inherent to such composition, mixture, process, method, article, or apparatus.

Additionally, the term “illustrative” is used herein to mean “serving as an example, instance or illustration.” Any embodiment or design described herein as “illustrative” is not necessarily to be construed as preferred or advantageous over other embodiments or designs. The terms “at least one” and “one or more” are understood to include any integer number greater than or equal to one, i.e., one, two, three, four, etc. The terms “a plurality” are understood to include any integer number greater than or equal to two, i.e., two, three, four, five, etc. The term “connection” can include an indirect “connection” and a direct “connection.”

References in the specification to “one embodiment,” “an embodiment,” “an example embodiment,” etc., indicate that the embodiment described can include a particular feature, structure, or characteristic, but every embodiment may or may not include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

The terms “about,” “substantially,” “approximately,” and variations thereof, are intended to include the degree of error associated with measurement of the particular quantity based upon the equipment available at the time of filing the application. For example, “about” can include a range of +8% or 5%, or 2% of a given value.

The descriptions of the various embodiments of the present invention have been presented for purposes of illustration but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments described herein.

The descriptions of the various embodiments of the present invention have been presented for purposes of illustration but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments described herein.

Thus, a computer implemented method, system or apparatus, and computer program product are provided in the illustrative embodiments for managing participation in online communities and other related features, functions, or operations. Where an embodiment or a portion thereof is described with respect to a type of device, the computer implemented method, system or apparatus, the computer program product, or a portion thereof, are adapted or configured for use with a suitable and comparable manifestation of that type of device.

Where an embodiment is described as implemented in an application, the delivery of the application in a Software as a Service (SaaS) model is contemplated within the scope of the illustrative embodiments. In a SaaS model, the capability of the application implementing an embodiment is provided to a user by executing the application in a cloud infrastructure. The user can access the application using a variety of client devices through a thin client interface such as a web browser (e.g., web-based e-mail), or other light-weight client-applications. The user does not manage or control the underlying cloud infrastructure including the network, servers, operating systems, or the storage of the cloud infrastructure. In some cases, the user may not even manage or control the capabilities of the SaaS application. In some other cases, the SaaS implementation of the application may permit a possible exception of limited user-specific application configuration settings.

Embodiments of the present invention may also be delivered as part of a service engagement with a client corporation, nonprofit organization, government entity, internal organizational structure, or the like. Aspects of these embodiments may include configuring a computer system to perform, and deploying software, hardware, and web services that implement, some or all of the methods described herein. Aspects of these embodiments may also include analyzing the client's operations, creating recommendations responsive to the analysis, building systems that implement portions of the recommendations, integrating the systems into existing processes and infrastructure, metering use of the systems, allocating expenses to users of the systems, and billing for use of the systems. Although the above embodiments of present invention each have been described by stating their individual advantages, respectively, present invention is not limited to a particular combination thereof. To the contrary, such embodiments may also be combined in any way and number according to the intended deployment of present invention without losing their beneficial effects.

What is claimed is:

1. A computer-implemented method comprising:
computing, using a trained embedding model, a query embedding representing an input query, the input query comprising a request for a recommended model and a recommended prompt template for use with the recommended model;
selecting a set of nearest neighbor embeddings with a distance less than a threshold distance from the query embedding in an embedding space;
predicting, using a trained confidence predictor model, a confidence value of each model-prompt template pair represented by a nearest neighbor embedding in the set of nearest neighbor embeddings, the predicting resulting in a set of predicted confidence values; and
constructing a response to the input query, the response comprising a model-prompt template pair selected using the predicted confidence values.

2. The computer-implemented method of claim 1, further comprising:
training a confidence predictor model to predict a confidence of a model-prompt template pair.

3. The computer-implemented method of claim 1, wherein the input query comprises an example of a task the recommended model and the recommended prompt template are being selected to perform.

4. The computer-implemented method of claim 1, wherein the input query comprises a query requesting a response from the recommended model using the recommended prompt template.

5. The computer-implemented method of claim 1, wherein the model-prompt template pair selected using the predicted confidence values comprises the model-prompt template pair with a highest average predicted confidence value.

6. The computer-implemented method of claim 1, further comprising:
confidence values, a plurality of candidate responses to the input query;
computing a plurality of similarity scores between pairs of candidate responses in the plurality of candidate responses; and
constructing a second response to the input query, the second response comprising a candidate response with a highest average similarity score.

7. A computer program product comprising one or more computer readable storage media, and program instructions collectively stored on the one or more computer readable storage media, the program instructions executable by a processor to cause the processor to perform operations comprising:
computing, using a trained embedding model, a query embedding representing an input query, the input query comprising a request for a recommended model and a recommended prompt template for use with the recommended model;
selecting a set of nearest neighbor embeddings with a distance less than a threshold distance from the query embedding in an embedding space;
predicting, using a trained confidence predictor model, a confidence value of each model-prompt template pair represented by a nearest neighbor embedding in the set of nearest neighbor embeddings, the predicting resulting in a set of predicted confidence values; and
constructing a response to the input query, the response comprising a model-prompt template pair selected using the predicted confidence values.

8. The computer program product of claim 7, wherein the stored program instructions are stored in a computer readable storage device in a data processing system, and wherein the stored program instructions are transferred over a network from a remote data processing system.

9. The computer program product of claim 7, wherein the stored program instructions are stored in a computer readable storage device in a server data processing system, and wherein the stored program instructions are downloaded in response to a request over a network to a remote data processing system for use in a computer readable storage device associated with the remote data processing system, further comprising:
program instructions to meter use of the program instructions associated with the request; and
program instructions to generate an invoice based on the metered use.

10. The computer program product of claim 7, further comprising:
training a confidence predictor model to predict a confidence of a model-prompt template pair.

11. The computer program product of claim 7, wherein the input query comprises an example of a task the recommended model and the recommended prompt template are being selected to perform.

12. The computer program product of claim 7, wherein the input query comprises a query requesting a response from the recommended model using the recommended prompt template.

13. The computer program product of claim 7, wherein the model-prompt template pair selected using the predicted confidence values comprises the model-prompt template pair with a highest average predicted confidence value.

14. The computer program product of claim 7, further comprising:
generating, using the model-prompt template pair selected using the predicted confidence values, a plurality of candidate responses to the input query;
computing a plurality of similarity scores between pairs of candidate responses in the plurality of candidate responses; and
constructing a second response to the input query, the second response comprising a candidate response with a highest average similarity score.

15. A computer system comprising a processor and one or more computer readable storage media, and program instructions collectively stored on the one or more computer readable storage media, the program instructions executable by the processor to cause the processor to perform operations comprising:
computing, using a trained embedding model, a query embedding representing an input query, the input query comprising a request for a recommended model and a recommended prompt template for use with the recommended model;
selecting a set of nearest neighbor embeddings with a distance less than a threshold distance from the query embedding in an embedding space;
predicting, using a trained confidence predictor model, a confidence value of each model-prompt template pair represented by a nearest neighbor embedding in the set of nearest neighbor embeddings, the predicting resulting in a set of predicted confidence values; and
constructing a response to the input query, the response comprising a model-prompt template pair selected using the predicted confidence values.

16. The computer system of claim 15, further comprising:
training a confidence predictor model to predict a confidence of a model-prompt template pair.

17. The computer system of claim 15, wherein the input query comprises an example of a task the recommended model and the recommended prompt template are being selected to perform.

18. The computer system of claim 15, wherein the input query comprises a query requesting a response from the recommended model using the recommended prompt template.

19. The computer system of claim 15, wherein the model-prompt template pair selected using the predicted confidence values comprises the model-prompt template pair with a highest average predicted confidence value.

20. The computer system of claim 15, further comprising:
confidence values, a plurality of candidate responses to the input query;
computing a plurality of similarity scores between pairs of candidate responses in the plurality of candidate responses; and
constructing a second response to the input query, the second response comprising a candidate response with a highest average similarity score.
